(19) United States
(12) Patent Application Publication
(10) Pub. No.: US 2026/0179369 A1
(43) Pub. Date: Jun. 25, 2026

(54) SUMMARY GENERATION APPARATUS, SUMMARY MODEL LEARNING APPARATUS, SUMMARY GENERATION METHOD, SUMMARY MODEL LEARNING METHOD, AND PROGRAM

(71) Applicant: NITT, Inc., Tokyo (JP)

(72) Inventors: Itsumi SAITO, Tokyo (JP); Kyosuke NISHIDA, Tokyo (JP); Sen YOSHIDA, Tokyo (JP)

(73) Assignee: NTT, Inc., Tokyo (JP)

(21) Appl. No.: 18/843,684

(22) PCT Filed: Mar. 4, 2022
(86) PCT No.: PCT/JP2022/009575

§ 371 Date: Sep. 3, 2024

(51) Int. Cl. G06V 10/82; G06F 16/31; G06F 18/214; G06V 10/764

(52) U.S. Cl. CPC G06V 10/82; G06F 16/313; G06F 18/214; G06V 10/764

(57) ABSTRACT

A summary generation device includes: an image processing unit that receives an input of an image related to a moving image, and extracts at least a text from the image; a sound processing unit that receives an input of sound in the moving image, and extracts at least a text from the sound; and a summary generation unit that generates a summary text of the moving image from information extracted from the image and information extracted from the sound, using a trained summary model.

### TECHNICAL FIELD

The present invention relates to a technology for generating a summary text of a moving image from the moving image.

### BACKGROUND ART

Online conferences and the like have increased in recent years, and a large number of moving images of presentations such as conferences are open to the public on the Internet.

A presentation video is normally long in terms of time, and therefore, it is necessary to watch the video for a long time to grasp its contents. Because of this, there is a demand for grasping the contents of a presentation video in a short time.

### CITATION LIST

### Non Patent Literature

Non Patent Literature 1: BART: Denoising Sequence-to-Sequence Pre-training for Natural Language Generation, Translation, and Comprehension

### SUMMARY OF INVENTION

### Technical Problem

To grasp the contents of a presentation video in a short time, it is conceivable to generate a text (summary text) indicating a summary of the presentation video.

However, conventional technologies do not include any technology for appropriately generating a summary text from a moving image including sound and images (slide images and the like), such as a presentation video.

The present invention has been made in view of the above aspects, and aims to provide a technology for appropriately generating a summary text from a moving image including sound and images.

### Solution to Problem

The disclosed technology provides a summary generation device that includes:
an image processing unit that receives an input of an image related to a moving image, and extracts at least a text from the image;
a sound processing unit that receives an input of sound in the moving image, and extracts at least a text from the sound; and
a summary generation unit that generates a summary text of the moving image from information extracted from the image and information extracted from the sound, using a trained summary model.

### Advantageous Effects of Invention

The disclosed technology provides a technology for appropriately generating a summary text from a moving image including sound and images.

### BRIEF DESCRIPTION OF DRAWINGS

FIG. 1 is a diagram illustrating the flow of a basic process of creating a summary text from a presentation video.

FIG. 2 is a configuration diagram of a summary generation device 100.

FIG. 3 is a flowchart for explaining an operation of the summary generation device 100.

FIG. 4 is a configuration diagram of a summary model training device 200.

FIG. 5 is a diagram illustrating a configuration for summary model pre-training.

FIG. 6 is a flowchart for explaining an operation of the summary model training device 200.

FIG. 7 is a diagram illustrating an example of an input to a summary model and an output from the summary model in pre-training.

FIG. 8 is a diagram for explaining a process of cutting out an image from a moving image.

FIG. 9 is a diagram for explaining text extraction from an image.

FIG. 10 is a diagram for explaining text extraction from sound.

FIG. 11 is a diagram illustrating an example of an input to a summary model and an output from the summary model in training.

FIG. 12 is a diagram illustrating the configuration of a data extension unit 400.

FIG. 13 is a flowchart for explaining an operation of the data extension unit 400.

FIG. 14 is a diagram illustrating an example of data dividing.

FIG. 15 is a diagram for explaining training using divided training data sets.

FIG. 16 is a diagram illustrating an example hardware configuration of a device.

FIG. 17 is a table illustrating the effects in cases where research paper data has been learned in advance.

FIG. 18 is a table illustrating the effects in cases where a slide outline has been learned in advance.

FIG. 19 is a table illustrating the effects in cases where training data sets obtained by dividing have been learned together with the original training data set.

### DESCRIPTION OF EMBODIMENTS

An embodiment of the present invention (the present embodiment) will be described below with reference to the drawings. The embodiment described below is merely an example, and embodiments to which the present invention is applied are not limited to the embodiment described below.

Both a summary generation device 100 and a summary model training device 200 described below provide a specific improvement over a conventional technology for generating a summary from a research paper, and indicate an improvement of the technical field related to a technology for generating a summary from a moving image.

A data extension unit 400 (a training data generation device 400) described below provides a specific improvement over a conventional technology for manually generating a summary, and indicates an improvement of the technical field related to a technology for training a summary model for generating a summary text of a moving image.

In the description below, a presentation video is used as a moving image from which a summary is to be generated. However, this is merely an example. The technology according to the present invention can be applied to moving images in general, not limited to presentation videos.

### Outline of the Embodiment

Online conferences and the like have increased in recent years, and a large number of moving images of presentations such as conferences are open to the public. A presentation video is normally long in terms of time, and therefore, there is a demand for grasping its contents in a short time. To grasp the contents of a presentation video in a short time, it is desirable that a summary of the presentation video can be generated.

Therefore, in the present embodiment, a technology for generating a summary text corresponding to a presentation video is described.

### <Example of a Presentation Video>

As disclosed in “https://slideslive.com/38928967/predicting-depression-in-screening-interviews-from-latent-categorization-of-interview-prompts” (searched on Feb. 27, 2022) “https://videolectures.net/” (searched on Feb. 27, 2022), and the like, an example of a presentation video normally includes an image of a slide in which the announcement contents are described, an image of the presenter, and a voice of the presenter. Note that there are many cases where any image of the presenter is not displayed.

<Flow of a Basic Process of Creating a Summary Text from a Presentation Video>

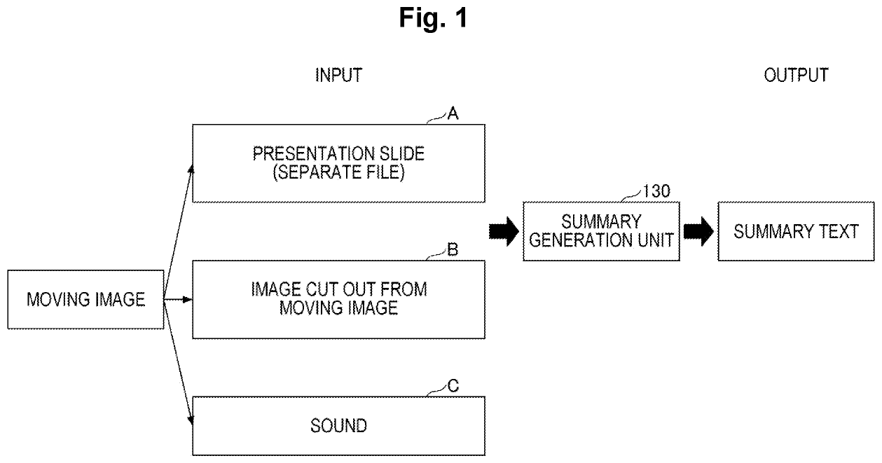

The flow of a basic process of creating a summary text from a presentation video is now described with reference to FIG. 1. Note that, in the description below, a presentation video will be referred to as a “moving image” in some cases, and a summary text will be referred to as a “summary” in some cases, for convenience in writing.

First, (A) a presentation slide, (B) an image cut out from a moving image, and (C) sound, which are input data to a summary generation unit 130, are prepared from the moving image to be subjected to summary creation.

Note that (A) the presentation slide is assumed to be a file separate from the moving image. Also, if there is at least one of the three items (A), (B), and (C) as the input data, a summary can be generated. However, to generate a more accurate summary, it is desirable that there are the three items (A), (B), and (C), or two items (A) and (C), or two items (B) and (C).

Next, the input data converted into a text by image recognition/speech recognition is input to the summary generation unit 130, and the summary generation unit 130 outputs a summary text. The summary generation unit 130 is a functional unit included in the summary generation device 100 described later.

### <Summary Generation Technology>

In the present embodiment, a neural network model (which is called a summary model) is used by the summary generation unit 130 to generate a summary from a text.

Although any summary model that receives a text input and outputs a summary text may be used, a model based on BART disclosed in Non Patent Literature 1 is used as an example in the present embodiment.

BART is a model including an encoder and a decoder. With a trained model, when a text is input to the encoder, a summary text is output from the decoder.

### <Problems>

There have been technologies for inputting a text and outputting a summary, but there have been no technologies for outputting a summary from multimodal input data. That is, conventional technologies do not include any technology for appropriately generating a summary text from a moving image including sound and images (slide images and the like), such as a presentation video.

When the above problem is divided into more specific problems from the viewpoint of the embodiment, it can be divided into the following Problems 1 to 3.
Problem 1: the creation cost for creating training data including the correct summary text to be used in training a summary model for generating a summary of a moving image is high.
Problem 2: there are no summary generation techniques using a summary model that extracts sound and images from a moving image and outputs a summary text using the sound and the images as inputs.
Problem 3: even if the correct summary text to be used in training a summary model for generating a summary of a moving image is successfully collected from an external server or the like, the amount of training data is small, and a highly accurate summary model cannot be generated.

In the description below, the configurations and operations of the summary generation device 100 that generates a summary from a presentation video, and the summary model training device 200 for generating (training) a summary model to be used in the summary generation device 100 are described. The technology described below solves the above Problems 1 to 3.

### (Configuration and Operation of the Summary Generation Device 100)

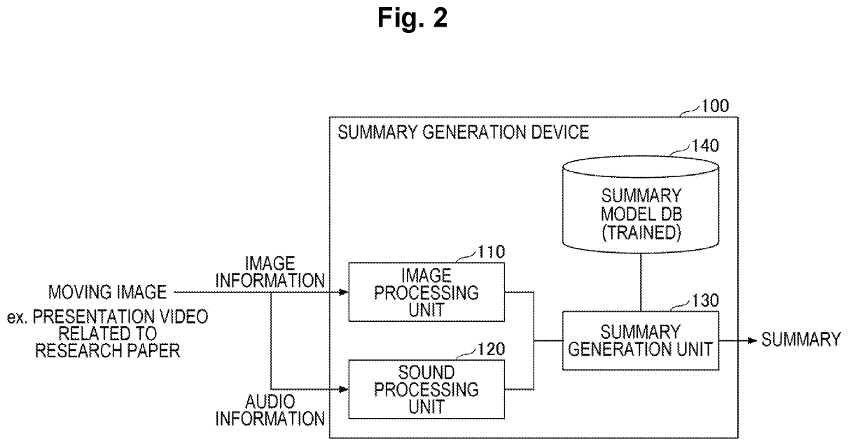

FIG. 2 illustrates a configuration diagram of the summary generation device 100 according to the present embodiment. As illustrated in FIG. 2, the summary generation device 100 includes an image processing unit 110, a sound processing unit 120, the summary generation unit 130, and a summary model database (DB) 140. A trained summary model is stored in the summary model DB 140. Note that a DB in the present specification may be called a memory unit or a storage unit.

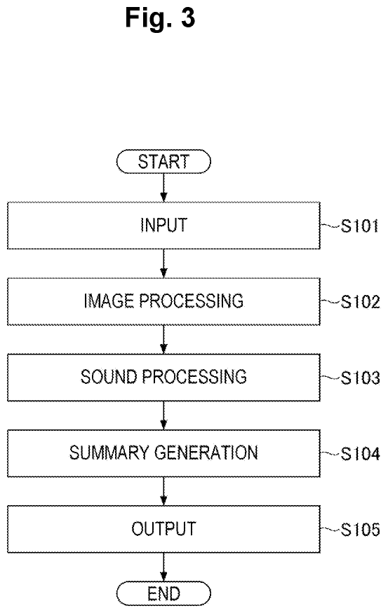

Referring now to a flowchart in FIG. 3, the flow of an operation to be performed by the summary generation device 100 illustrated in FIG. 2 is described.

Audio information and image information are extracted from a moving image from which a summary is to be created. In S101, the image information is input to the image processing unit 110, and the audio information is input to the sound processing unit 120. Note that, in the example in FIG. 2, it is assumed that a functional unit that extracts audio information and image information (particularly image information) from a moving image is located outside the summary generation device 100. However, the functional unit may be provided inside the summary generation device 100.

In S102, the image processing unit 110 extracts a text from the image, using an image recognition technology. In addition to the text, the image processing unit 110 may extract accompanying auxiliary information (such as the color of the characters shown in a slide).

In S103, the sound processing unit 120 extracts a text from the sound, using a speech recognition technology. Note that the order of the processes in S102 and S103 may be reversed, or S102 and S103 may be carried out simultaneously.

The text extracted in S102 and the text extracted in S103 are input to the summary generation unit 130. In S104, the summary generation unit 130 generates a summary from the text extracted in S102 and the text extracted in S103, using a summary model read from the summary model DB 140. As will be explained in the description of summary model training, information obtained by adding any one, a plurality, or all of the layout feature amount, the image feature amount, and the speech feature amount of the characters may be used, in addition to the text, as an input to the summary model. Note that the actual form of the “summary model” is data including a function, a weight parameter, and the like that constitute a neural network. In S104, the summary generation unit 130 outputs the generated summary.

As described above, it is possible to generate a high-quality summary by using both audio information and image information obtained from a moving image.

The processes in the functional unit that extracts audio information and image information from a moving image, the image processing unit 110, and the sound processing unit 120 are the same as the processes in a training data input unit 220, an image processing unit 230, and a sound processing unit 240 of the summary model training device 200 described later, respectively. Therefore, these processes will be explained later in detail in the description of the summary model training device 200.

Problem 2 mentioned above is solved by the summary generation device 100 according to the present embodiment, and it is possible to achieve a summary generation technology using a summary model that extracts sound and an image from a moving image, and outputs a summary text using the sound and the image as inputs. Note that training of the summary model is performed by the summary model training device 200 described below.

### (Configuration and Operation of the Summary Model Training Device)

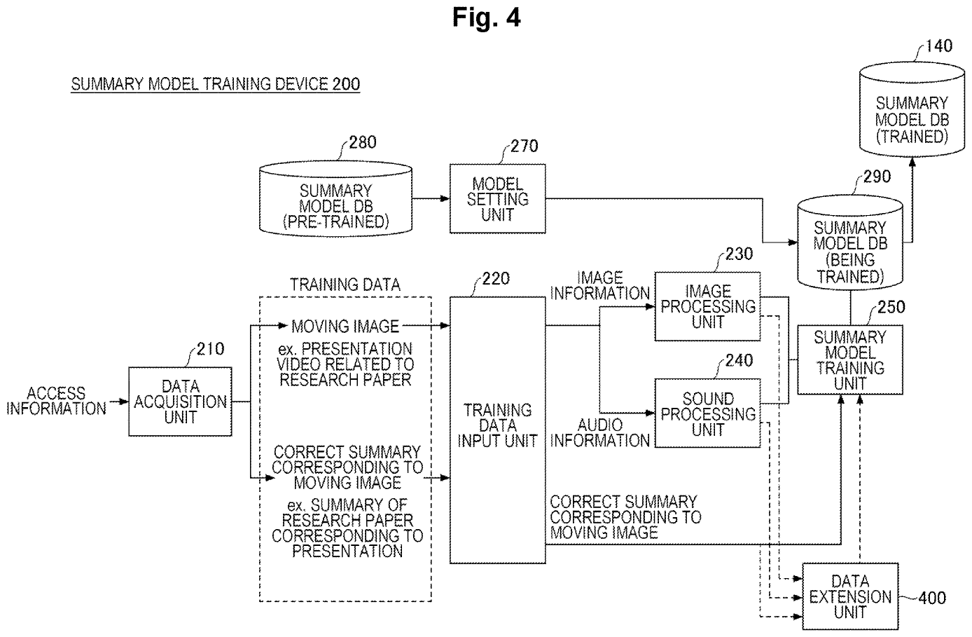

FIG. 4 illustrates an example configuration of the summary model training device 200 according to the present embodiment. As illustrated in FIG. 4, the summary model training device 200 includes a data acquisition unit 210, the training data input unit 220, the image processing unit 230, the sound processing unit 240, a summary model training unit 250, the data extension unit 400, a model setting unit 270, a summary model DB 280 that stores a pre-trained summary model, and a summary model DB 290 that stores a summary model being trained.

In the present embodiment, during training of a summary model, a summary model that has learned beforehand a large amount of summaries of papers considered to have high degrees of similarity to the presentation in terms of contents is created, and fine-tuning is performed on the summary model with a small amount of summary data of the presentation. As a result, it is possible to achieve high accuracy even with a small amount of correct summary data of the presentation video.

Note that performing pre-training as described above is one of the solutions to Problem 3. Problem 3 can also be solved with the use of additional training data generated by the data extension unit 400 described later, even without pre-training performed. Performing pre-training and using additional training data generated by the data extension unit 400 described later may be combined.

Although the configuration illustrated in FIG. 4 is the configuration in a case where the above pre-training is performed, training based on training data generated by the data extension unit 400 may be performed without the pre-training. Alternatively, the training based on the training data generated by the data extension unit 400 may be performed on a summary model subjected to the pre-training.

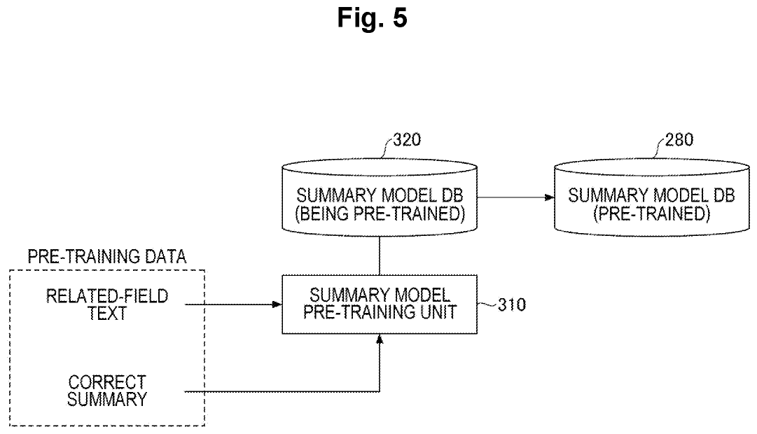

FIG. 5 illustrates the configuration for pre-training. As illustrated in FIG. 5, the configuration for pre-training includes a summary model pre-training unit 310, and a summary model DB 320 that stores a summary model being pre-trained.

A summary model pre-training device (a device different from the summary model training device 200) including the summary model pre-training unit 310 and the summary model DB 320 may be formed, or the summary model pre-training unit 310 and the summary model DB 320 may be included in the summary model training device 200.

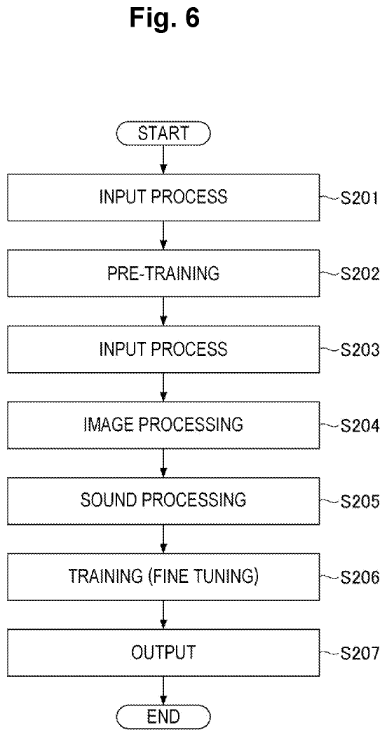

Referring now to a flowchart in FIG. 6, the flow of an operation to be performed by the summary model training device 200 and the summary model pre-training unit 310 is described. The processes will be described later in detail.

S201 and S202 are processes in the configuration for pre-training illustrated in FIG. 5. In S201, pre-training data is input to the summary model pre-training unit 310. The pre-training data is the text of a research paper related to the presentation and a summary (correct answer data) of the research paper, for example.

In S202, the summary model pre-training unit 310 trains (pre-trains) the summary model, using the input data. The pre-trained summary model is stored in the summary model DB 280 in the summary model training device 200.

S203 to S207 are processes to be performed in the summary model training device 200 illustrated in FIG. 4. In the input process in S203, access information (for example, the URLs at which the research paper and the presentation video are open to the public) is input to the data acquisition unit 210. Using the access information, the data acquisition unit 210 acquires training data from a server in the network, for example, and inputs the training data to the training data input unit 220. The training data is a presentation video related to the research paper and the correct summary text corresponding to the video, for example. Further in S203, the training data input unit 220 performs a process of dividing the presentation video into image information and audio information, inputs the image information to the image processing unit 230, inputs the audio information to the sound processing unit 240, and inputs the correct summary to the summary model training unit 250.

Note that the image information the training data input unit 220 inputs to the image processing unit 230 may be a slide image or the like that is a file separate from the presentation video, or may be a slide image or the like extracted from the presentation video. In either case, the image may be expressed as an “image related to the moving image”. In either case, a text can be extracted from the “image related to the moving image” by an image recognition process.

Note that, in the description below, it is assumed that the image information to be input to the image processing unit 230 is a slide image or the like extracted from the presentation video.

In S204, the image processing unit 230 extracts a text from the image, using an image recognition technology. In addition to the text, the image processing unit 230 may extract accompanying auxiliary information (such as the color of the characters shown in a slide), the layout feature amount of the characters, the image feature amount, and the like.

In S205, the sound processing unit 240 extracts a text from the sound, using a speech recognition technology. The sound processing unit 240 may extract a speech feature amount or the like, in addition to the text. Note that the order of the processes in S204 and S205 may be reversed, or S204 and S205 may be carried out simultaneously.

The text extracted in S204 and the text extracted in S205 are input to the summary model training unit 250. The correct summary is also input to the summary model training unit 250.

Here, the pre-trained summary model is read from the summary model DB 280 by the model setting unit 270, and the pre-trained summary model is stored into the summary model DB 290. The training (fine tuning) described below is performed, using the parameters in the pre-trained summary model as the initial values.

In S206, the summary model training unit 250 generates a summary from the text extracted in S204 and the text extracted in S205, using the summary model read from the summary model DB 290, and performs training (parameter updating) of the summary model so as to minimize the error between the generated summary and the correct summary.

When the training is completed, the summary model training unit 250 stores the trained summary model into the summary model DB 140 of the summary generation device 100.

Note that, in the example described above, pre-training is performed to fine-tune the pre-trained training model. However, pre-training is not essential as described above. The process may be started from S203 in FIG. 6, without any pre-training performed. The initial values of the parameters of the summary model in a case where pre-training is not performed may be random values, or may be values that are not random values.

In the following, the processing contents in each step in S201 to S207 are described in greater detail.

### (S201, S202: Pre-Training)

A detailed example of pre-training to be performed by the summary model pre-training unit 310 illustrated in FIG. 5 is now described. In the pre-training, training of the summary model is performed, using a text (called a related-field text) in a field related to the field of the presentation video to be summarized, and a correct summary thereof. The related-field text is a research paper text (the body text of a research paper), a text in a slide, or the like, for example.

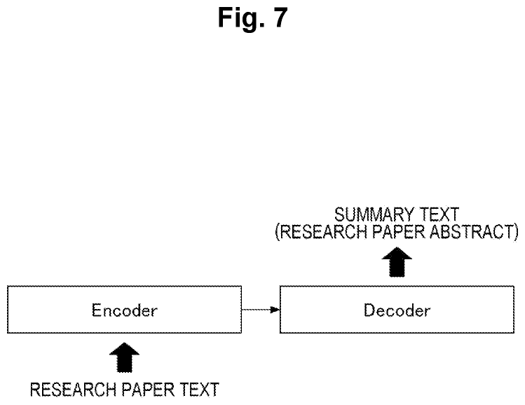

FIG. 7 illustrates an example of an input to the summary model and an output from the summary model in a case where a research paper text is used as the related-field text. As described above, the summary model according to the present embodiment is a model including an encoder and a decoder.

As illustrated in FIG. 7, the body text of a research paper is input to the encoder, and a summary text is output from the decoder. Training of the summary model is performed so as to minimize the error between the summary text to be output and the correct summary text. In a case where a slide text is used as the input, the processing contents are the same as those in a case where a research paper text is used.

Note that, when a text is input to the encoder, the token strings in the text are first converted into fixed d-dimensional vectors, and are then converted into a summary text through the encoder and the decoder.

An example of a research paper text as an input is shown below.

“We assume familiarity with basic notions of graph theory (see, for instance, 1]) and with elementary notions of polyhedral combinatorics (see, for instance, 6]).”, “Our graphs will be undirected and simple (no loops and no multiple edges).”, “As usual, K n denotes the complete graph with n vertices; K n;m denotes the complete bipartite graph with n+m vertices and n m edges.”, “Let G be a graph; G is connected if for every pair of distinct vertices there exists a path in G joining them; G is two-connected if for every vertex v of G, the graph G?”, “v is connected; G is planar if it can be embedded in the plane.”, “A subgraph H of a G is spanning if the vertex sets of H and G are the same.”, “Subdivision of an edge uv of G consists of removing edge uv, and adding a new vertex w and the two edges uw and vw; w is called subdivision vertex.”, “If G and H are two graphs, we say that G contains a subdivision of H, if H arises by subdivision of the edges of some subgraph of G. As usual, (u) denotes the set of all edges that are incident in the vertex u.”, “In automatic graph drawing the following problem arises: nd in a complete graph with weights on its edges a two-connected planar spanning subgraph with weight as Partially supported by DFG-Grant JU204/7-1 Forschungsschwerpunkt Y” E ziente Algorithmen f ur diskrete Probleme und ihre Anw . . . ”

An example of an output (or a summary text that is correct answer data) with respect to the input is shown below.

“The problem of finding a two-connected planar spanning subgraph of maximum weight in a complete edge-weighted graph is important in automatic graph drawing.”, “We investigate the problem from a polyhedral point of view.”

On a presentation video site or the like, there are cases where a slide file can be acquired as a file separate from the video. Further, in many cases, a slide file contains the data of the slide (a slide text) and an outline of the slide (a summary text). In such a case, pre-training of the summary model can be performed, using the slide text as an input to the encoder and the decoder, and the summary text as the correct summary.

An example of a slide text serving as an input is shown below.

“[[“ssn”], [“MASTERS”, “IN”, “AUTOMOTIVE”], [“ENGINEERING”], [“Karthiek”, “Nagaraj”], [“PRESENTED”, “AT”, “IRIS”, “,”, “DEPARTMENT”, “OF”, “MECHANICAL”, “ENGINEERING”], [“SSN”], [“WHY”, “AUTOMOBILE”, “ENGINEERING”, “?”], [“Its”, “scope”, “is”, “irrefutable”, “and”, “job”, “prospects”, “are”, “very”, “strong”, “in”, “any”, “part”, “of”, “the”, “world”, “.”, “Also”, “the”, “prospect”, “of”, “returning”, “to”, “India”, “to”, “work”, “is”, “bright”, “as”, “the”, “indian”, “automotive”, “industry”, “is”, “making”, “tremendous”, “progress”, “.”], [“>”, “It”, “is”, “a”, “stream”, “which”, “blends”, “passion”, “for”, “vehicles”, “and”, “technical”, “knowledge”, “,”, “thus”, “making”, “it”, “all”, “the”, “more”, “interesting”, “.”], [“It”, “is”, “an”, “interdisciplinary”, “field”, “which”, “encompasses”, “mechanical”, “engineering”, “,”, “electrical”, “and”, “electronics”, “engineering”, “and”, “software”, “engineering”, “.”, “This”, “again”, “adds”, “to”, “the”, “interest”, “factor”, “.”], [” A″, “multitude”, “of”, “research”, “options”, “are”, “on”, “offer”, “,”, “especially”, “in”, “hybrid”, “powertrains”, “and”, “fuel”, “cells”, “.”], [” PRESENTED″, “AT”, “IRIS”, “,”, “DEPARTMENT”, “OF”, “MECHANICAL”, “ENGINEERING”], [“2”], [“SSN”], [“KEY”, “AREAS”, “OF”, “AUTOMOTIVE”, “ENGINEERING”], [“Vehicle”, “Propulsion”, “˜”, “Internal”, “combustion”, “engines”], [“Powertrain”, “dynamics”, “and”, “control”], [“Vehicle”, “dynamics”, “˜”, “Handling”, “response”], [“˜”, “Advanced”, “transmission”], [“systems”], [“˜”, “Hybrid”, “propulsion”, “systems”], [“˜”, “Terrain”, “modelling”], [“˜”, “Fuel”, “cells”], [“˜”, “Drivetrain”, “control”, “systems”], [“˜”, “NVH”, “modelling”], [“Automotive”, “body”, “structures”, “˜”, “Material”, “selection”], [“Automotive”, “safety”, “˜”, “Active”, “and”, “passive”, “safety”], [“systems”], [“˜”, “Crash”, “worthiness”], [“˜”, “Human”, “factor”, “engineering”], [“and”,”

An example of an output (or a slide summary that is correct answer data) with respect to the input is shown below.

“A Guide to Masters in Automotive Engineering at International Destinations”

### (S203: The Input Process in the Summary Model Training Device 200)

Next, a detailed example of the process to be performed by the data acquisition unit 210 and the process to be performed by the training data input unit 220 in the summary model training device 200 illustrated in FIG. 4 is described.

The data acquisition unit 210 accesses a presentation video site on the Internet, for example, and acquires the presentation video and the correct summary corresponding to the video from the site. An example of such a site from which a moving image and summary can be acquired is “https://aclanthology.org/” (searched on Feb. 27, 2022), for example.

As described above, by acquiring a presentation video and a summary thereof from a server in the network, training data can be created without a manually created summary, and Problem 1 mentioned above is solved.

The training data input unit 220 performs a process of dividing the presentation video acquired by the data acquisition unit 210 into image information and audio information, inputs the image information to the image processing unit 230, and inputs the audio information to the sound processing unit 240.

The image information is not limited to any particular image, but it is assumed here that the image information is a slide image in the presentation video.

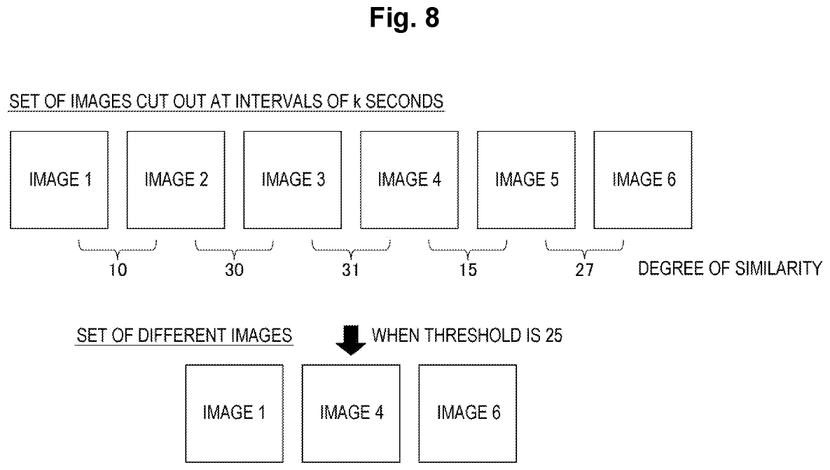

Referring now to FIG. 8, an example of the process to be performed by the training data input unit 220 to cut out an image from the presentation video is described.

### S203(1-1):

The training data input unit 220 cuts out an image from the presentation video every k seconds. Here, k is a real number greater than 0, and is a predetermined number. The upper half of FIG. 8 illustrates six images cut out at intervals of k seconds.

### S203(1-2):

The training data input unit 220 compares the images cut out in S203(1-1) in order of time, and determines that these images are the same images when the degree of similarity between the t-th image and the (t-1)th image is equal to or higher than a threshold. Note that any determination method may be used as the method for determining the similarity between the images. FIG. 8 illustrates an example of the degree of similarity between each two images among the six images.

### S203(1-3):

The training data input unit 220 repeats S203(1-1) and S203(1-2), to extract a set of different images. FIG. 8 illustrates image 1, image 4, and image 6 as a set of different images in a case where the threshold is 25. The obtained image set is input to the image processing unit 230.

### (S204: Image Processing)

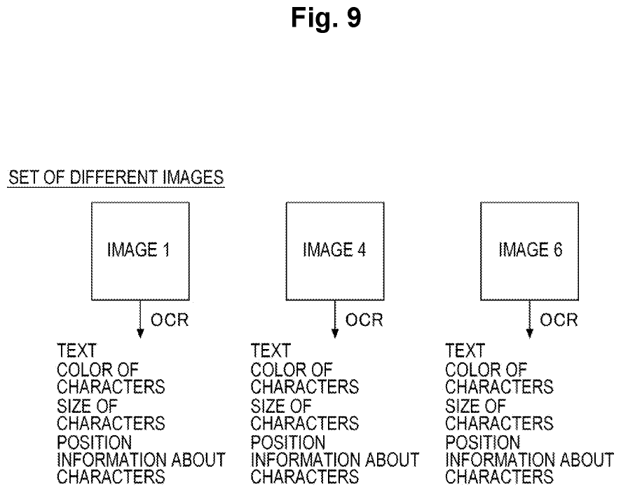

Next, a detailed example of the image processing to be performed by the image processing unit 230 is described. The image processing unit 230 performs an optical character recognition (OCR) process on the set of different images input from the training data input unit 220, and, as illustrated in FIG. 9, acquires a text, the color of the characters, the size of the characters, position information about the characters, and the like from each image in the set of different images. Note that the information to be acquired may be only the text.

### (S205: Sound Processing)

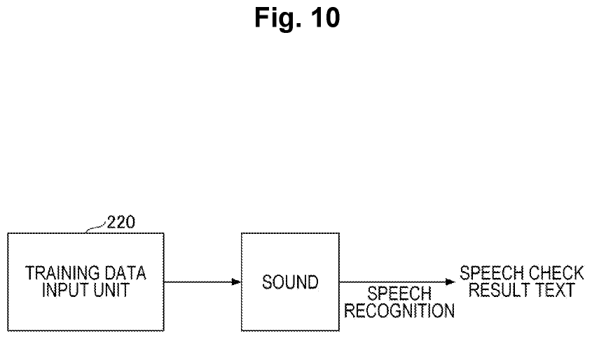

Next, a detailed example of the sound processing to be performed by the sound processing unit 240 is described. As illustrated in FIG. 10, the sound processing unit 240 performs a speech recognition process on the sound input from the training data input unit 220, and acquires a text of a speech recognition result.

### (S206: Training Process)

Next, a detailed example of the training process to be performed by the summary model training unit 250 is described. The summary model training unit 250 combines the text obtained by the image processing unit 230 and the text obtained by the sound processing unit 240, and inputs the combined text to the summary model. The summary model training unit 250 trains the summary model so that the error between the summary text output from the summary model and the correct summary text is minimized. As for the input to the summary model, information obtained by adding the layout feature amount of the characters, the image feature amount, the size of the characters, color information about the characters, and the like obtained by the image processing unit 230 to the combined text may be used. Also, information obtained by adding the speech feature amount obtained by the sound processing unit 240 to the combined text may be used.

Note that the initial state of the above summary model is the summary model pre-trained in S202. However, pre-training may not be performed as mentioned above, and therefore, the initial state of the summary model may not be the summary model pre-trained in S202. In a case where pre-training is not performed, training may be performed using additional training data generated by the data extension unit 400 described later.

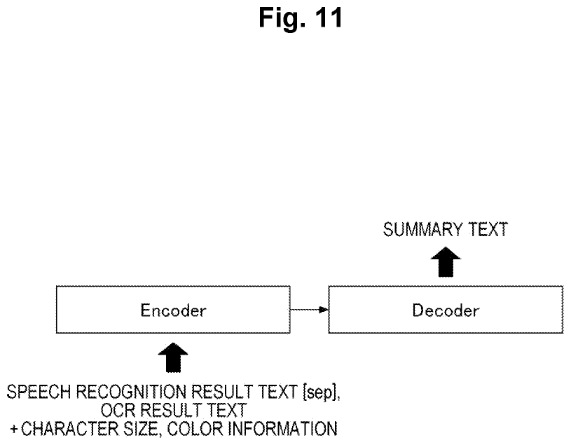

An example of an input to the summary model and an output from the summary model is illustrated in FIG. 11. As described above, the summary model according to the present embodiment is a model including an encoder and a decoder.

As illustrated in FIG. 11, the text combined by [September], the size of the characters, and the color information are input to the encoder, and a summary text is output from the decoder. Training of the summary model is performed so as to minimize the error between the summary text to be output and the correct summary text.

When a text is input to the encoder, the token strings in the text are first converted into fixed d-dimensional vectors, and are then converted into a summary text through the encoder and the decoder. Alternatively, the size of the characters and the color information may not be included in the input.

Note that the text to be obtained by the sound processing unit 240 may be referred to as an automatic speech recognition (ASR) text, and the text to be obtained by the image processing unit 230 may be referred to as an OCR text.

An example of the ASR text is shown below.

“So to put in context to put my presentation in the context, I will, I would like to begin with the word decision support or decision-making. And first ask the question who, or what is making decisions and obviously we get two branches here. One is that we have a human decision maker who makes a decision and all of us are decision makers and then we are also talking about the decision systems. So computers robots.”

An example of the OCR text is shown below. The example shown below is an example of a text obtained from a slide image disclosed in “http://videolectures.net/site/normal_dl/tag=1005123/icm12015_schmidt_time_framework_01.pdf” (searched on Feb. 26, 2022).

“Structured sparsity sparsity is widely used in signal processing, machine learning, and statistics (compressive sensing, sparse linear regression, etc.) Examples of sparsity . . . .”

An example of the summary text (or the correct summary text) that is output when the ASR text and the OCR text are combined and are input to the summary model is shown below.

“Decision Support is a discipline concerned with human decision making: it aims to provide methods and tools that support, rather than replace, people in making difficult decisions. One of the widely used decision-support approaches relies on decision models, which are developed in the decision process and used to evaluate and analyse decision alternatives. In this lecture, we shall present the method DEX (Decision EXpert), which was heavily influenced by ideas from Artificial Intelligence. DEX is a hierarchical, qualitative, rule-based, multi-criteria modelling method, suitable particularly for solving classification decision problems. DEX combines traditional approaches with those from expert systems and machine learning. DEX is supported by the software called DEXi and has been used in hundreds of real-world decision-making studies. The presentation will be illustrated by recent applications in the areas of electric energy production, food safety and health care.”

### (Configuration and Operation of the Data Extension Unit 400)

In the description below, a technique for automatically generating an additional training data set, which is one of the techniques for solving Problem 3, is explained.

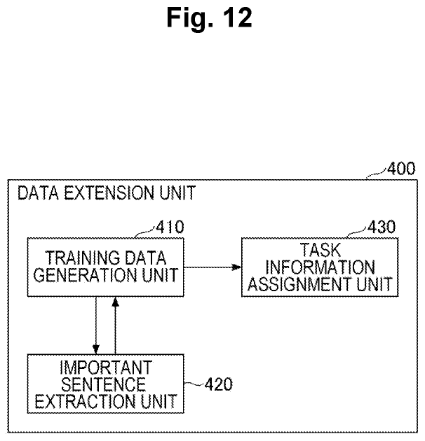

FIG. 12 illustrates the configuration of the data extension unit 400 in the summary model training device 200 illustrated in FIG. 4. As illustrated in FIG. 12, the data extension unit 400 includes a training data generation unit 410, an important sentence extraction unit 420, and a task information assignment unit 430. Note that the data extension unit 400 may be a functional unit in the summary model training device 200, or may be a separate device disposed outside the summary model training device 200. The summary model training device 200 in a case where the data extension unit 400 is in the summary model training device 200 may be referred to as the training data generation device 400. In a case where the data extension unit 400 is a separate device disposed outside the summary model training device 200, the separate device may be referred to as the training data generation device 400.

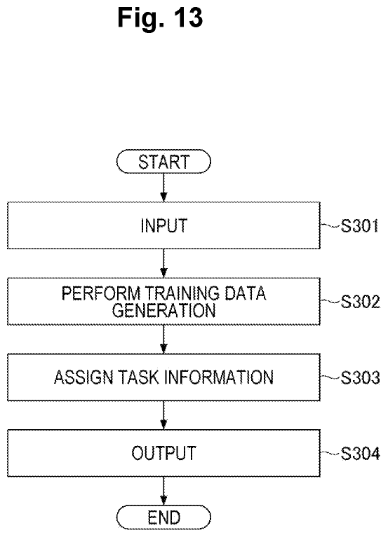

Referring now to a flowchart in FIG. 13, the flow of an operation to be performed by the data extension unit 400 (the training data generation device 400) illustrated in FIG. 12 is described. In S301, the ASR text obtained by sound processing, the OCR text obtained by image processing, and the correct summary text corresponding to these texts are input to the training data generation unit 410.

In S302, the training data generation unit 410 performs a training data generation process (which may also be referred to as the data division process) on the input data. In S302, the important sentence extraction unit 420 also performs an important sentence extraction process. Note that the important sentence extraction unit 420 may be included in the training data generation unit 410.

The task information assignment unit 430 assigns task information to the generated training data set in S303, and outputs the training data set assigned with the task information in S304. The output data is input to the summary model training unit 250, and is used in training the summary model. In the following, the above processes in the respective steps are described in greater detail.

### (S301: Input, S302: Data Dividing)

Data is input to the training data generation unit 410, with “an OCR text, an ASR text, the correct summary text” as one set for one presentation video. A data set for performing training is called a training data set.

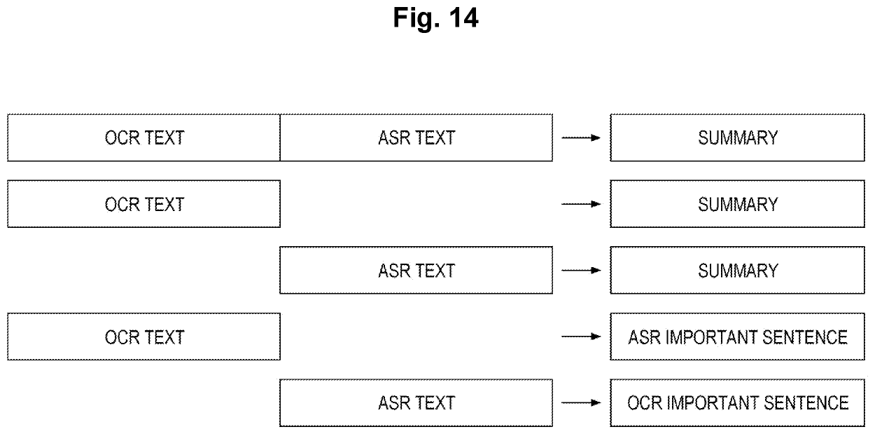

On the basis of the above input data, the training data generation unit 410 generates the five training data sets listed below, as illustrated in FIG. 14. Note that (1) is the original training data set. Since each training data set represents a task, a training data set may be called a task. Note that the five sets listed below are examples, and at least one additional training data set is only required to be generated in addition to the original training data set. In addition to the sets listed below, (6) an OCR text and an OCR important sentence, and (7) an ASR text and an ASR important sentence may be generated.
(1) An OCR text, an ASR text, and the correct summary text
(2) An OCR text and the correct summary text
(3) An ASR text and the correct summary text
(4) An OCR text and an ASR important sentence
(5) An ASR text and an OCR important sentence

Both an ASR important sentence and an OCR important sentence are an example of pseudo correct answer information. Both an ASR important sentence and an OCR important sentence are created by the important sentence extraction unit 420. An example of the method for creating these important sentences is described below.

As for an ASR important sentence, the important sentence extraction unit 420 extracts an ASR important sentence by performing matching between a summary text with an ASR text. For example, the important sentence extraction unit 420 extracts an ASR important sentence that is a portion of the ASR text, the portion having a high degree of similarity to the summary text.

As for an OCR important sentence, the important sentence extraction unit 420 extracts an OCR important sentence by performing matching between the summary text with an OCR text. For example, the important sentence extraction unit 420 extracts an OCR important sentence that is a portion of the OCR text, the portion having a high degree of similarity to the summary text.

An appropriate method can be adopted as the matching method for extracting an ASR/OCR important sentence, but a method disclosed in Fine-tune BERT for Extractive Summarization (https://arxiv.org/pdf/1903.10318v2.pdf, searched on Feb. 27, 2022) that is used in creation of extracted summary data may be used, for example.

### (S303: Task Information Assignment)

The task information assignment unit 430 assigns identification information (which may be called a label) for identifying a task, to each training data set generated by the training data generation unit 410. The identification information is a special token. In the above examples (1) to (5), identification information such as [task0] is assigned as shown below, for example.
(1) [task0] An OCR text, an ASR text, and the correct summary text
(2) [task1] An OCR text and the correct summary text
(3) [task2] An ASR text and the correct summary text
(4) [task3] An OCR text and an ASR important sentence
(5) [task4] An ASR text and an OCR important sentence

### (S304: Output, (and Training))

Each task (each training data set) to which the identification information is attached in S303 is output to the summary model training unit 250.

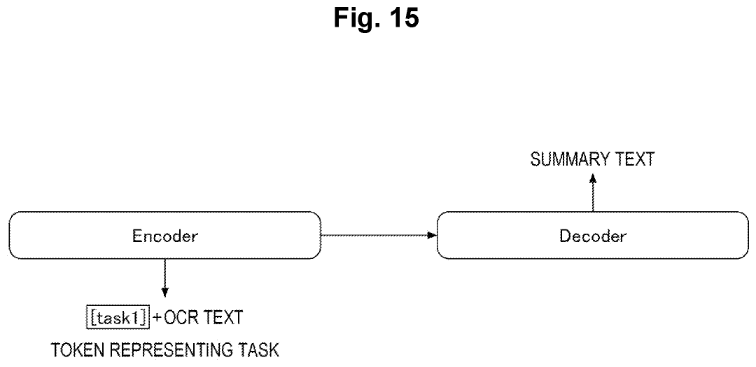

The summary model training unit 250 trains the summary model, using each training data set to which the identification information is attached. The training method with each training data set is similar to the training method in S206 described above. However, as illustrated in FIG. 15, a text to which the identification information is attached is used in inputting to the decoder herein. FIG. 15 illustrates an example of training with the task (2) among the above five tasks. Such training is performed with each of (1) to (5).

Thus, the amount of training data can be increased, and a highly accurate summary model can be generated.

### (Example Hardware Configuration)

All of the summary generation device 100, the summary model training device 200, and the training data generation device 400 can be implemented by causing a computer to execute a program, for example. This computer may be a physical computer, or may be a virtual machine in a cloud. Hereinafter, the summary generation device 100, the summary model training device 200, and the training data generation device 400 will be collectively referred to as the “apparatus”.

Specifically, the apparatus can be implemented by executing a program corresponding to the processing to be performed in the apparatus, using hardware resources such as a CPU and a memory included in the computer. The above program can be recorded in a computer-readable recording medium (such as a portable memory) to be stored and distributed. The above program can also be provided through a network such as the Internet or electronic mail.

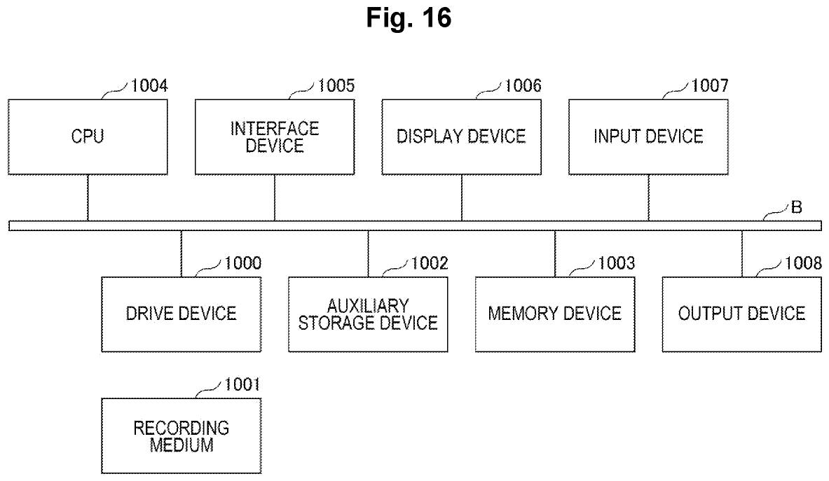

FIG. 16 is a diagram illustrating an example hardware configuration of the computer. The computer in FIG. 16 includes a drive device 1000, an auxiliary storage device 1002, a memory device 1003, a CPU 1004, an interface device 1005, a display device 1006, an input device 1007, an output device 1008, and the like, which are connected to one another by a bus BS.

The program for performing processing in the computer is provided through a recording medium 1001 such as a CD-ROM or a memory card, for example. When the recording medium 1001 storing the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is issued, the memory device 1003 reads the program from the auxiliary storage device 1002 and stores the program. The CPU 1004 implements functions related to the apparatus, according to the program stored in the memory device 1003. The interface device 1005 is used as an interface for connection to a network or the like. The display device 1006 displays a graphical user interface (GUI) or the like according to the program. The input device 1007 includes a keyboard and a mouse, buttons, a touch-screen, or the like, and is used to input various operation instructions. The output device 1008 outputs a calculation result.

### Effects of the Embodiment

As described above, the technology according to the present embodiment enables appropriate generation of a summary text from a moving image that includes sound and images, such as a presentation video. Also, it is possible to automatically generate additional training data for training a summary model for generating a summary text from a moving image.

In particular, according to the present embodiment, the accuracy of a summary model can be increased by pre-training or data extension (additional training data generation through data dividing).

In the description below, effects based on experimental results in a case where pre-training was performed, and effects based on experimental results in a case where data dividing was performed are explained. In the description below, ROUGE-1, ROUGE-2, and ROUGE-L are used as evaluation indexes, and are written as R1, R2, and RL, respectively.

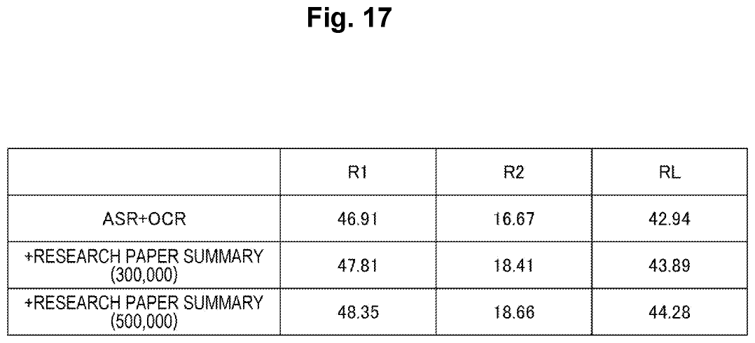

FIG. 17 is a table illustrating the effects in cases where research paper data has been learned in advance. For comparison, “ASR+OCR” indicates evaluation results in a case where research paper data has not been learned in advance. “+Research paper summary (300,000)” and “+research paper summary (500,000)” indicate the evaluation results in cases where 300,000 and 500,000 research paper summaries have been learned in advance, respectively. As can be seen from FIG. 17, the accuracy is higher when research paper data has been learned in advance.

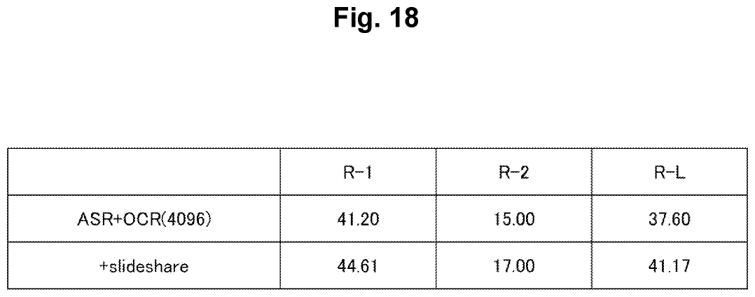

FIG. 18 is a table illustrating the effects in cases where a slide outline has been learned in advance. For comparison, “ASR+OCR (4096)” indicates evaluation results in a case where a slide outline has not been learned in advance. Further, “+slideshare” indicates evaluation results in a case where a slide outline has been learned in advance. As can be seen from FIG. 18, the accuracy is higher when a slide outline has been learned in advance.

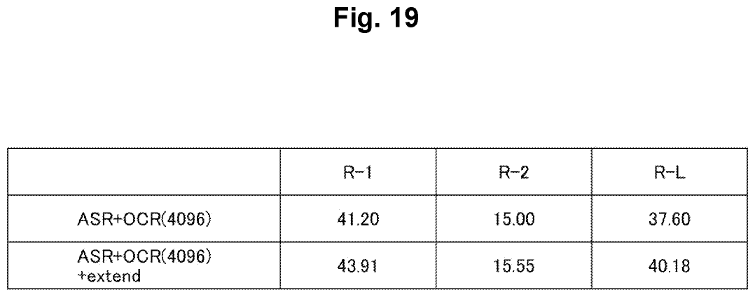

FIG. 19 is a table illustrating the effects in cases where further training data sets obtained by dividing have been learned together with the original training data set. For comparison, “ASR+OCR (4096)” indicates evaluation results in a case where only the original training data set has been learned. “ASR+OCR (4096)+extend” indicates evaluation results in a case where the further training data sets obtained by dividing have been learned together with the original training data set. As can be seen from FIG. 19, the accuracy is higher when the training data sets obtained by dividing are learned together with the original training data set.

### (Supplementary Notes)

Regarding the embodiment described above, the following supplementary notes are further disclosed herein.

### (Supplementary Note 1)

A summary generation device including:
a memory; and
at least one processor connected to the memory,
in which
the processor
receives an input of an image related to a moving image, and extracts at least a text from the image,
receives an input of sound in the moving image, and extracts at least a text from the sound, and
generates a summary text of the moving image from information extracted from the image and information extracted from the sound, using a trained summary model.

### (Supplementary Note 2)

A summary model training device including:
a memory; and
at least one processor connected to the memory,
in which
the processor
receives an input of an image related to a moving image, and extracts at least a text from the image;
receives an input of sound in the moving image, and extracts at least a text from the sound; and
trains a summary model, using information extracted from the image, information extracted from the sound, and a correct summary text of the moving image.

### (Supplementary Note 3)

The summary model training device according to supplementary note 2, in which
the processor acquires the moving image and the correct summary text from a server in a network.

### (Supplementary Note 4)

The summary model training device according to supplementary note 2, in which
the processor performs pre-training on the summary model, using a text in a field related to the moving image and a correct summary text of the text.

### (Supplementary Note 5)

The summary model training device according to supplementary note 2, in which
the processor generates at least one further training data set from a training data set that includes the information extracted from the image, the information extracted from the sound, and the correct summary text of the moving image.

### (Supplementary Note 6)

A summary generation method implemented by a computer, the summary generation method including:
an image processing step of extracting at least a text from an image related to a moving image;
a sound processing step of extracting at least a text from sound in the moving image; and
a summary generating step of generating a summary text of the moving image from information extracted from the image and information extracted from the sound, using a trained summary model.

### (Supplementary Note 7)

A non-transitory storage medium storing a program executable by a computer to perform a summary generation process in the summary generation device according to supplementary note 1.

### (Supplementary Note 8)

A non-transitory storage medium storing a program executable by a computer to perform a summary model training process in the summary model training device according to any one of supplementary notes 2 to 5.

While the present embodiment has been described so far, the present invention is not limited to such a specific embodiment, and various modifications and changes can be made within the scope of the present invention disclosed in the claims.

### REFERENCE SIGNS LIST

100 summary generation device
110 image processing unit
120 sound processing unit
130 summary generation unit
140 summary model DB
200 summary model training device
210 data acquisition unit
220 training data input unit
230 image processing unit
240 sound processing unit
250 summary model training unit
270 model setting unit
280 summary model DB
290 summary model DB
310 summary model pre-training unit
320 summary model DB
400 data extension unit
410 training data generation unit
420 important sentence extraction unit
430 task information assignment unit
1000 drive device
1001 recording medium
1002 auxiliary storage device
1003 memory device
1004 CPU
1005 interface device
1006 display device
1007 input device
1008 output device

1. A device comprising a processor configured to execute operations comprising:
receiving an input of an image related to a moving image, and extracts at least a text from the image;
receiving an input of sound in the moving image, and extracts at least a text from the sound; and
generating a summary text of the moving image from information extracted from the image and information extracted from the sound, using a trained summary model.

2. A device comprising a processor configured to execute operations comprising:
receiving an input of an image of a moving image;
extracting at least a first training text from the image;
receiving an input of sound in the moving image;
extracting at least a second training text from the sound; and
training a summary model, using the first training text, the second training text, and a correct summary text of the moving image.

3. The device according to claim 2, the processor further configured to execute operations comprising:
acquiring the moving image and the correct summary text from a server in a network.

4. The device according to claim 2, the processor further configured to execute operations comprising:
performing pre-training on the summary model, using a pre-training text in a field associated with the moving image and a correct summary text of the pre-training text.

5. The device according to claim 2, the processor further configured to execute operations comprising:
generating at least one further training data set from a training data set,
wherein the training data set comprises first information extracted from the image, second information extracted from the sound, and the correct summary text of the training moving image,
the first information extracted from the image comprises the first training text, and
the second information extracted from the sound comprises the second training text.

6. A method implemented by a computer, comprising:
a first image processing step of extracting at least a text from an image related to a moving image;
a first sound processing step of extracting at least a text from sound in the moving image; and
a summary generating step of generating a summary text of the moving image from information extracted from the image related to the moving image and information extracted from the sound, using a trained summary model.

7. The method according to claim 6, comprising:
a second image processing step of extracting at least a first training text from a training image related to a training moving image;
a second sound processing step of extracting at least a second training text from sound in the training moving image; and
a summary model training step of training a summary model, using the first training text, the second training text, and a correct summary text of the training moving image.

8. (canceled)

9. The device according to claim 1, wherein the image related to the moving image is based on a frame of the moving image.

10. The device according to claim 1, the processor further configured to execute operations comprising:
performing pre-training on a summary model, using a pre-training text in a field associated with a pre-training moving image and a correct summary text of the pre-training text.

11. The device according to claim 10, the processor further configured to execute operations comprising:
receiving an input of a training image of a training moving image;
extracting at least a first training text from the training image;
receiving an input of training sound in the training moving image;
extracting at least a second training text from the training sound; and
training the summary model, using the first training text, the second training text, and a correct summary text of the training moving image.

12. The device according to claim 11, wherein a first amount of training data based on a first combination comprising the pre-training text and the correct summary text of the pre-training text is larger than a second amount of training data based on a second combination comprising the first training text, the second training text, and the correct summary text of the training moving image, and the training of the summary model represents a fine-tuning of the summary model.

13. The device according to claim 11, the processor further configured to execute operations comprising:
acquiring the training moving image and the correct summary text from a server in a network.

14. The method according to claim 6, further comprising:
performing pre-training on a summary model, using a pre-training text in a field associated with a pre-training moving image and a correct summary text of the pre-training text.

15. The method according to claim 6, further comprising:
wherein the image related to the moving image is based on a frame of the moving image.

16. The method according to claim 7, further comprising:
acquiring the training moving image and the correct summary text from a server in a network.

17. The method according to claim 7, further comprising:
performing pre-training on the summary model, using a pre-training text in a field associated with a pre-training moving image and a correct summary text of the pre-training text.

18. The method according to claim 17,
wherein a first amount of training data comprising a first combination of the pre-training text and the correct summary text of the pre-training text is larger than a second amount of training data comprising a second combination of the first training text, the second training text, and the correct summary text of the training moving image, and
the training of the summary model represents a fine-tuning of the summary model.
